(19) United States
(12) Patent Application Publication
(10) Pub. No.: US 2025/0316279 A1
(43) Pub. Date: Oct. 9, 2025

(54) AUDIO PROCESSING METHOD AND APPARATUS, AND DEVICE

(71) Applicant: Beijing Zitiao Network Technology Co., Ltd., Beijing (CN)

(72) Inventors: He WANG, Beijing (CN); Shenyi SONG, Beijing (CN); Dejun ZHANG, Beijing (CN); Ziqian WU, Beijing (CN); Jiawei JIANG, Beijing (CN); Kunpeng LIN, Beijing (CN); Jian XU, Beijing (CN); Yijian XIAO, Beijing (CN); Piao DING, Beijing (CN)

(21) Appl. No.: 19/245,094

(22) Filed: Jun. 20, 2025

Related U.S. Application Data
(63) Continuation of application No. PCT/CN2023/140319, filed on Dec. 20, 2023.

(30) Foreign Application Priority Data
Dec. 20, 2022 (CN) 202211644420.4

(51) Int. Cl. G10L 19/008

(52) U.S. Cl. CPC G10L 19/008

(57) ABSTRACT

An audio processing method and apparatus, and a device are provided. The method comprises: obtaining at least two audio encoded streams and extension bitstreams according to an audio frame; and generating encoded data of the audio frame on the basis of the at least two audio encoded streams and extension bitstreams.

### CROSS-REFERENCE TO RELATED APPLICATIONS

This application is a continuation application, under 35 USC 111(a), of International Patent Application No. PCT/CN2023/140319, filed on Dec. 20, 2023, which is based on and claims priority to CN Application No. 202211644420.4 filed on Dec. 20, 2022, the disclosures of both of which are hereby incorporated by reference in their entireties.

### TECHNICAL FIELD

The present disclosure relates to the technical field of audio processing, and in particular, to an audio processing method and apparatus, and device.

### BACKGROUND

When network signals are poor, audio data packets are easily lost in their transmission process, thereby affecting continuity of audio signals. In view of this, an electronic device may adopt a packet loss prevention technique to improve the continuity of the audio signals.

Currently, an electronic device may adopt an in-band Forward Error Correction (FEC) technique to improve the quality of audio signals. For example, when the electronic device transmits audio data packets, an audio data packet of a previous frame with a low code rate may be carried in an audio data packet of a current frame through the FEC technique. When the audio data packet of the previous frame are lost, a receiving end can recover audio data of the previous frame through the audio data packet of the current frame, so that random packet loss can be effectively prevented. However, when network fluctuation is large, sudden continuous packet loss may occur.

### SUMMARY

The present disclosure provides an audio processing method and apparatus, and device.

In a first aspect, the present disclosure provides an audio processing method, including: acquiring at least two audio encoded streams and an extension bitstream according to an audio frame; and generating encoded data of the audio frame based on the at least two audio encoded streams and the extension bitstream.

In a second aspect, the present disclosure provides another audio processing method, including: acquiring at least two audio encoded streams and an extension bitstream according to encoded data of an audio frame; and decoding the at least two audio encoded streams and the extension bitstream to obtain the audio frame.

In a third aspect, the present disclosure provides an audio processing apparatus, including: an acquisition module configured to acquire at least two audio encoded streams and an extension bitstream according to an audio frame; and a generation module configured to generate encoded data of the audio frame based on the at least two audio encoded streams and the extension bitstream.

In a fourth aspect, the present disclosure provides an audio processing apparatus, including: an acquisition module configured to acquire at least two audio encoded streams and an extension bitstream according to encoded data of an audio frame; and a decoding module configured to decode the at least two audio encoded streams and the extension bitstream to obtain the audio frame.

In a fifth aspect, an embodiment of the present disclosure provides an electronic device, including: one or more processors and one or more memories, where the one or more memories are configured to store computer-executable instructions, which when executed by the one or more processors cause the one or more processors to perform the audio processing method according to the first aspect or the audio processing method according to the second aspect as described above.

In a sixth aspect, an embodiment of the present disclosure provides a computer-readable storage medium having stored thereon computer-executable instructions which, when executed by a processor, cause the processor to implement the audio processing method according to the first aspect as described above, or the audio processing method according to the second aspect as described above.

In a seventh aspect, an embodiment of the present disclosure provides a computer program comprising instructions which, when executed by a processor, cause the processor to perform the audio processing method according to the first aspect as described above, or the audio processing method according to the second aspect as described above.

### BRIEF DESCRIPTION OF THE DRAWINGS

In order to more clearly illustrate the embodiments of the present disclosure or the technical solutions in the prior art, the drawings used in the description of the embodiments or the prior art will be briefly described below, and it is obvious that the drawings in the following description are some embodiments of the present disclosure, and those skilled in the art can obtain other drawings without creative labor.

FIG. 1 is a schematic diagram of an application scenario provided by some embodiments of the present disclosure;

FIG. 2 is a schematic flow diagram of an audio processing method provided by some embodiments of the present disclosure;

FIG. 3 is a schematic diagram of a process for acquiring an audio frame provided by some embodiments of the present disclosure;

FIG. 4 is a schematic diagram of a multiple description coding provided by some embodiments of the present disclosure;

FIG. 5 is a schematic diagram of a process for acquiring an audio encoded stream provided by some embodiments of the present disclosure;

FIG. 6A is a schematic diagram of an extension bitstream provided by some embodiments of the present disclosure;

FIG. 6B is a schematic diagram of an extension bitstream provided by some embodiments of the present disclosure;

FIG. 6C is a schematic diagram of an extension bitstream provided by some embodiments of the present disclosure;

FIG. 6D is a schematic diagram of an extension bitstream provided by some embodiments of the present disclosure;

FIG. 7A is a schematic diagram of a process for generating encoded data provided by some embodiments of the present disclosure;

FIG. 7B is a schematic diagram of another process for generating encoded data provided by some embodiments of the present disclosure;

FIG. 8 is a schematic diagram of another audio processing method provided by some embodiments of the present disclosure;

FIG. 9 is a schematic structural diagram of an audio processing apparatus provided by some embodiments of the present disclosure;

FIG. 10 is a schematic structural diagram of another audio processing apparatus provided by some embodiments of the present disclosure;

FIG. 11 is a schematic structural diagram of an electronic device provided by some embodiments of the present disclosure.

### DETAILED DESCRIPTION

Description will now be made in detail to the exemplary embodiments, examples of which are illustrated in the accompanying drawings. When the following description refers to the accompanying drawings, the same number in different drawings represents the same or similar elements unless otherwise indicated. The implementations described in the exemplary embodiments below do not represent all implementations consistent with the present disclosure. Rather, they are merely examples of apparatus and method consistent with certain aspects of the disclosure, as detailed in the appended claims.

For ease of understanding, the following will explain concepts related to the embodiments of the present disclosure.

A first device (encoding device) may be a device having a wireless transceiving function, or may be in the form of an encoder or the like. The first device may be deployed on land, including indoors or outdoors, hand-held, worn, or vehicle-mounted; and can also be deployed on water surface (such as a ship). The first device may be a cellphone (mobile phone), a tablet computer (Pad), a computer with a wireless transceiving function, a Virtual Reality (VR) device, an Augmented Reality (AR) device, a wireless terminal in industrial control, a vehicle-mounted device, a wireless terminal in self-driving, a wireless device in remote medical, a wireless device in smart grid, a wireless device in transportation safety, a wireless device in smart city, a wireless device in smart home, a wearable device, and the like. The first device involved in the embodiments of the present disclosure may also be referred to as a terminal, a User Equipment (UE), an access device, a vehicle-mounted terminal, an industrial control terminal, a UE unit, a UE station, a mobile station, a remote station, a remote device, a mobile device, a UE electronic device, a wireless communication device, a UE agent, or a UE device. The electronic device may also be fixed or mobile. In some embodiments, a second device (decoding device) may be a decoder, and the second device, like the first device, may also be a device having a wireless transceiving function, or the like, which is not limited in this disclosure.

In the related art, in order to avoid the problem that audio data packets are easily lost during transmission to affect continuity of audio signals, an electronic device may adopt a packet loss prevention technique to improve continuity of audio. Currently, the electronic device can prevent the problem of audio packet loss through the in-band FEC technique. For example, an audio data packet of a current frame transmitted by the electronic device may carry low code rate audio data coding of a previous frame, and when an audio data packet of the previous frame is lost, a receiving end may decode the audio data coding of the previous frame carried by the audio data packet of the current frame, so as to obtain the audio data of the previous frame. However, the above method can only cope with a scenario of random packet loss, and when network fluctuation is large, sudden continuous packet loss will occur in the audio data packets, so that the receiving end cannot effectively recover the audio data. For example, if audio data packets of 10 frames of are continuously lost, and an audio data packet of each frame of audio only carry the audio data coding of the previous frame, the receiving end cannot recover the 10 lost frames of audio, which causes audio lag, and further causes a poor audio playing effect.

In order to solve the technical problem in the related art, some embodiments of the present disclosure provide an audio processing method, in which a first device acquires at least two audio encoded streams and an extension bitstream according to an audio frame; and generates encoded data of the audio frame based on the at least two audio encoded streams and the extension bitstream. After receiving the encoded data, a second device may decode the encoded data to obtain an audio frame. In this way, since the encoded data of the audio frame can carry at least two audio encoded streams and the extension bitstream, when continuous packet loss occurs, the second device can recover the audio frame with continuous packet loss based on the at least two audio encoded streams, the extension bitstream can also assist the second device in recovering the audio frame, and bandwidth extension data can improve the quality of the audio frame, thereby improving the audio playing effect.

An application scenario of an embodiment of the present disclosure is described below with reference to FIG. 1.

FIG. 1 is a schematic diagram of an application scenario provided by an embodiment of the present disclosure. Referring to FIG. 1, a first device and a second device are included. After the first device acquires an audio frame, it determines encoded data associated with the audio frame, where the encoded data may include an audio encoded stream 1, an audio encoded stream 2, and an extension bitstream, and the extension bitstream may include audio coding of a previous 1st (N=1) frame and bandwidth extension data. Data carried by the audio encoded stream 1 and the audio encoded stream 2 are the same, the audio coding of the previous 1st frame is coding of a previous 1st audio frame of the audio frame, and the bandwidth extension data can improve the playing definition of the audio frame.

Referring to FIG. 1, the first device may transmit the audio encoded stream 1, the audio encoded stream 2, the audio coding of the previous 1st frame, and the bandwidth extension data to the second device, and the second device may decode the encoded data based on the audio encoded stream 1, the audio encoded stream 2, the audio coding of the previous 1st frame, and the bandwidth extension data to obtain the audio frame and play the audio frame. In this way, when continuous packet loss occurs in a poor network, the second device can recover the audio frame with continuous packet loss based on the at least two audio encoded streams, audio encoded data of a previous Nth frame can also assist the second device in recovering the audio frame, and the bandwidth extension data can improve the quality of the audio frame, thereby improving the audio playing effect.

It should be noted that, FIG. 1 only illustrates an application scenario of the embodiment of the present disclosure by way of example, but does not limit the application scenario of the embodiment of the present disclosure.

The following describes the technical solutions of the present disclosure and how to solve the above technical problem in detail with specific embodiments. The following several specific embodiments may be combined with each other, and details of the same or similar concepts or processes may not be repeated in some embodiments. The embodiments of the present disclosure will be described below with reference to the accompanying drawings.

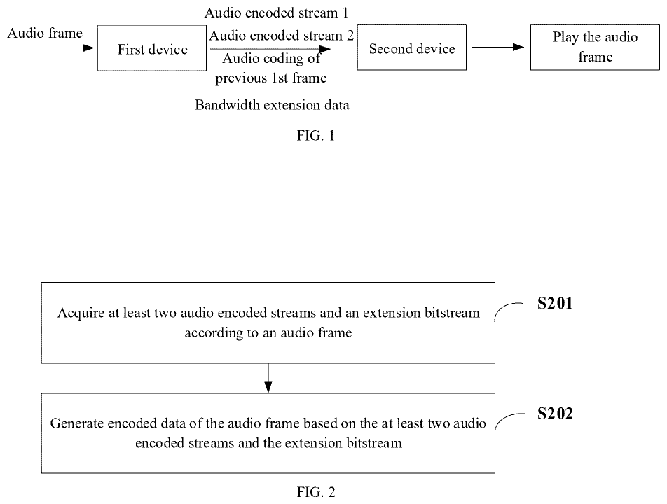

FIG. 2 is a schematic flow diagram of an audio processing method according to an embodiment of the present disclosure. Referring to FIG. 2, the method may include: step S201 to step S202. An execution subject of this embodiment may be the first device, and may also be an audio processing apparatus provided in the first device. In some embodiments, the audio processing apparatus may be implemented based on software, or may be implemented based on a combination of software and hardware, which is not limited in this disclosure.

In step S201, at least two audio encoded streams and an extension bitstream are acquired according to an audio frame.

An audio frame is acquired.

In some embodiments, the audio frame may be an audio frame in an audio to be sent. For example, a segment of audio may include 10 audio frames, and when the first device transmits the segment of audio, the first device may determine any audio frame as an audio frame to be sent.

In some embodiments, the audio frame may also be a current audio frame in the audio. For example, a segment of audio includes an audio frame A and an audio frame B, and if the current audio frame is the audio frame A, the audio frame acquired by the first device may be the audio frame A, and if the current audio frame is the audio frame B, the audio frame acquired by the first device may be the audio frame B.

In some embodiments, the first device may acquire the audio frame in real time. For example, in a scenario where the first device and the second device communicate in real time, the first device may acquire a voice uttered by a user in real time, thereby obtaining an audio frame. In some embodiments, the first device may also acquire the audio frame based on other manners (for example, the first device may acquire a pre-stored audio file in a database, to obtain the audio frame in the audio corresponding to the audio file), which is not limited in this disclosure.

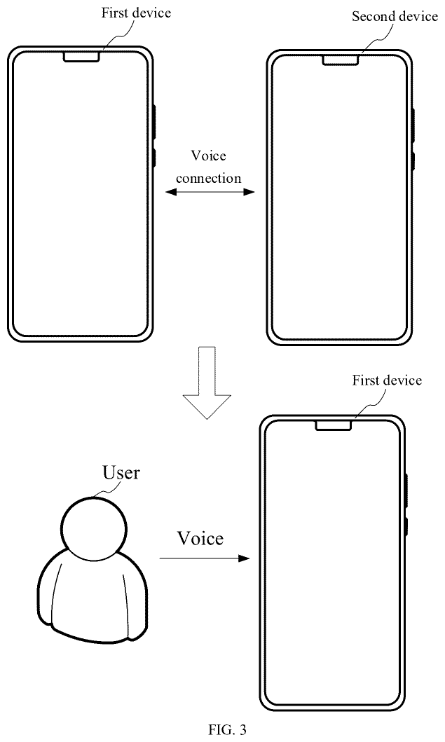

A process for acquiring an audio frame will be described below with reference to FIG. 3.

FIG. 3 is a schematic diagram of a process for acquiring an audio frame provided by an embodiment of the present disclosure. Referring to FIG. 3, a first device, a second device and a user are included, where the first device is in voice connection with the second device. The user may utter a voice to the first device, and the first device determines an audio frame in the received voice as an audio frame to be sent.

In some embodiments, the audio encoded stream may be an encoded stream associated with the audio frame. The at least two audio encoded streams are associated with multiple description coding of the audio frame, and may be generated by using multiple description coding, and the at least two audio encoded streams may be used for decoding the audio frame. For example, the audio encoded stream may be a multiple description bitstream, and by processing the audio frame by the multiple description coding, at least two multiple description bitsteams can be obtained, and the multiple description bitstreams may be determined as the audio encoded streams by the first device. The at least two audio encoded streams may be in a known format, for example, Opus format.

It should be noted that the encoded data carried by the at least two audio encoded streams may be the same, the receiving end may obtain a complete audio frame by decoding a single audio encoded stream, and when receiving any one or more audio encoded streams, the receiving end can improve the speech quality of the decoded audio frame.

In some embodiments, the first device may determine the at least two audio encoded streams with which the audio frame is associated based on the following possible implementation: acquiring audio information of the audio frame. For example, the audio information may include at least one of: a frame length, coding bandwidth and channel number of the audio frame, and the audio information may also include other information of the audio frame, which is not limited in this disclosure.

The audio frame is encoded based on a multiple description coding mode to obtain at least two data bitstreams. For example, the first device may encode the audio frame based on the multiple description coding mode, and then may obtain two equally encoded data bitstreams associated with the audio frame.

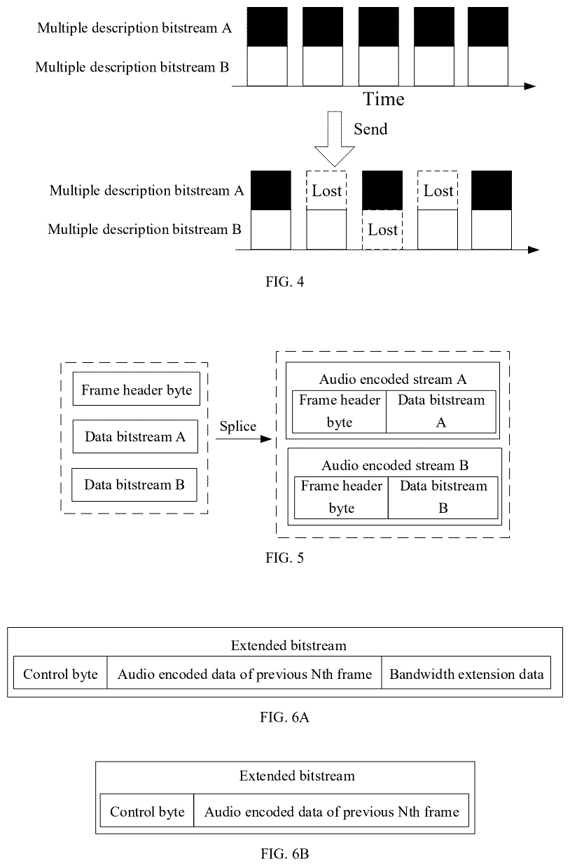

The multiple description coding mode will be described below with reference to FIG. 4.

FIG. 4 is a schematic diagram of a multiple description coding provided by an embodiment of the present disclosure. Please refer to FIG. 4, where a time axis is included. There are a multiple description bitstream A and a multiple description bitstream B on the time axis includes obtained based on multiple description coding. After the multiple description bitstream A and the multiple description bitstream B are transmitted, the multiple description bitstream A loses two audio data packets, and the multiple description bitstream B loses one audio data packet. However, by the multiple description bitstream A and the multiple description bitstream B, the audio can be completely decoded, so that the problem of audio lag caused by packet loss can be effectively reduced, and the quality of the audio is improved.

At least two audio encoded streams are determined according to the audio information and the at least two data bitstreams. For example, the audio information is respectively combined with the at least two data bitstreams to obtain at least two audio encoded streams. For example, a frame header byte of the data bitstream is determined based on the audio information, and the header byte is respectively combined with the at least two data bitstreams to obtain at least two audio encoded streams. For example, the frame header byte determined by the first device is frame header A, the first device processes the audio frame based on the multiple description coding mode to obtain a data bitstream A and a data bitstream B, and the frame header A is respectively combined with the two data bitstreams to obtain two audio encoded streams, where one audio encoded stream is frame header A-data bitstream A, and the other audio encoded stream is frame header A-data bitstream B.

A process for acquiring an audio encoded stream will be described below with reference to FIG. 5.

FIG. 5 is a schematic diagram of a process for acquiring an audio encoded stream provided by an embodiment of the present disclosure. Referring to FIG. 5, a frame header byte, a data bitstream A and a data bitstream B are included, where, the frame header byte is obtained based on an audio frame, and the data bitstream A and the data bitstream B are obtained based on multiple description coding of the audio frame. The frame header byte, the data bitstream A and the data bitstream B are spliced to obtain an audio encoded stream A and an audio encoded stream B. The audio encoded stream A may include the header byte and the data bitstream A, and the audio encoded stream B may include the header byte and the data bitstream B.

In some embodiments, the extension bitstream may include audio encoded data of a previous Nth frame of the audio frame and/or bandwidth extension data of the audio frame, where N is an integer greater than 0. For example, the audio encoded data of the previous Nth frame may be previous 1st frame, previous 2nd frames, or previous 3rd frames of the audio frame, etc. For example, the first device acquires 1st audio frame, 2nd audio frame, 3rd audio frame, and 4th audio frame of the audio to be transmitted, and if the audio frame encoded by the first device is the 4th audio frame and N is 2, the previous 2nd audio frame is the 2nd audio frame.

In some embodiments, the bandwidth extension data is associated with a decoding bandwidth of the audio frame. The decoding bandwidth may be a bandwidth of the audio frame after the audio frame is obtained by decoding. For example, the first device may determine the bandwidth extension data based on a Bandwidth Extension (BWE) technique, by which quality in playing the audio frame may be improved. For example, the bandwidth extension data of the audio frame may be determined by processing the audio frame through the BWE technique, and the receiving end decodes the audio frame according to the bandwidth extension data, which can improve the bandwidth of the audio frame, thereby improving the definition of the audio frame.

In step S202, encoded data of the audio frame is generated based on the at least two audio encoded streams and the extension bitstream.

In some embodiments, the at least two audio encoded streams and the extension bitstream are determined as the encoded data of the audio frame. Each of the at least two audio encoded streams may correspond to one extension bitstream, or each of part of the at least two audio encoded streams may correspond to one extension bitstream.

In some embodiments, each of the at least two audio encoded streams and one extension bitstream corresponding to the each of the at least two audio encoded streams are recombined into one bitstream as the encoded data of the audio frame, in a case where the each of the at least two audio encoded streams corresponds to one extension bitstream; or each of part of the at least two audio encoded streams and one extension bitstream corresponding to the each of the part of the at least two audio encoded streams are recombined into one bitstream, and the recombined bitstream and an audio encoded stream except the part of the audio encoded streams are determined as the encoded data of the audio frame, in a case where the each of the part of the at least two audio encoded streams corresponds to one extension bitstream.

In some embodiments, the generating encoded data of the audio frame based on the at least two audio encoded streams and the extension bitstream includes: generating a control byte based on the at least two audio encoded streams and the extension bitstream, wherein the control byte comprises at least one of configuration information of the at least two audio encoded streams, configuration information of an in-band forward error correction coding (FEC) or configuration information of bandwidth extension data; and writing the control byte into the encoded data of the audio frame.

In some embodiments, the configuration information of the at least two audio encoded streams comprises at least one of a number of the at least two audio encoded streams, or an index of each of the at least two audio encoded streams; the configuration information of the in-band FEC comprises information indicating whether in-band FEC data is carried, wherein the audio encoded data of the previous Nth frame is the in-band FEC data; and the configuration information of the bandwidth extension data comprises information indicating whether the bandwidth extension data is carried.

The first device may generate a control byte, and write the control byte to the encoded data of the audio frame. In some embodiments, the control byte includes at least one of the following parameters: the number of the at least two audio encoded streams, the index of each of the at least two audio encoded streams, a flag bit (configuration information of the in-band FEC) of the audio encoded data of the previous Nth frame, and a flag bit of the bandwidth extension data (configuration information of the bandwidth extension data). For example, if the first device processes the audio frame based on multiple description coding to obtain two audio encoded streams, the number of the audio encoded streams is 2.

The index of the audio encoded stream is used to indicate the audio encoded stream. For example, if the number of audio encoded streams is 2, the indexes of the audio encoded streams may indicate two audio encoded streams. For example, the number of audio encoded streams is 2, if the index of an audio encoded stream is 0, the audio encoded stream indicated by the index is the 1st audio encoded stream, and if the index of an audio encoded stream is 1, the audio encoded stream indicated by the index is the 2nd audio encoded stream.

The flag bit of the audio encoded data of the previous Nth frame is used to indicate whether the audio encoded data of the previous Nth frame (i.e., in-band FEC data) is carried in the extension bitstream. For example, if the flag bit of the audio encoded data of the previous Nth frame in the control byte is 0, the audio encoded data of the previous Nth frame does not exist in the extension bitstream, and if the flag bit of the audio encoded data of the previous Nth frame in the control byte is 1, the audio encoded data of the previous Nth frame is carried in the extension bitstream.

The flag bit of the bandwidth extension data is used to indicate whether the extension bitstream carries the bandwidth extension data. For example, if the flag bit of the bandwidth extension data in the control byte is 0, the bandwidth extension data does not exist in the extension bitstream, and if the flag bit of the bandwidth extension data in the control byte is 1, the bandwidth extension data is carried in the extension bitstream.

In some embodiments, the first device may determine the extension bitstream based on a network state. For example, if the network state is good, the extension bitstream may include the audio encoded data of the previous Nth frame and the bandwidth extension data, and the control byte indicates that the extension bitstream includes the audio encoded data of the previous Nth frame and the bandwidth extension data, and if the network state is poor, the extension bitstream may include the audio encoded data of the previous Nth frame or the bandwidth extension data, and the control byte indicates that the extension bitstream includes the audio encoded data of the previous Nth frame or the bandwidth extension data.

In some embodiments, the control byte may also be a preset byte in the first device. For example, the first device may preset that the flag bit of the bandwidth extension data in the control byte corresponding to the 1st audio encoded stream is 1, the flag bit of the audio encoded data of the previous Nth frame is 0, the flag bit of the bandwidth extension data in the control byte corresponding to the 2nd audio encoded stream is 0, and the flag bit of the audio encoded data of the previous Nth frame is 1.

In some embodiments, writing the control byte to the encoded data of the audio frame includes: writing the control byte into the extension bitstream, where: the configuration information of the in-band FEC is configured for indicating that the in-band FEC data is carried, and the configuration information of the bandwidth extension data is configured for indicating that the bandwidth extension data is carried, in a case where the extension bitstream comprises the in-band FEC data and the bandwidth extension data; the configuration information of the in-band FEC is configured for indicating that the in-band FEC data is carried, and the configuration information of the bandwidth extension data is configured for indicating that the bandwidth extension data is not carried, in a case where the extension bitstream comprises the in-band FEC data and does not comprise the bandwidth extension data; the configuration information of the in-band FEC is configured for indicating that the in-band FEC data is not carried, and the configuration information of the bandwidth extension data is configured for indicating that the bandwidth extension data is carried, in a case where the extension bitstream does not comprise the in-band FEC data and comprises the bandwidth extension data; and the configuration information of the in-band FEC is configured for indicating that the in-band FEC data is not carried, and the configuration information of the bandwidth extension data is configured for indicating that the bandwidth extension data is not carried, in a case where the extension bitstream does not comprise the in-band FEC data and the bandwidth extension data.

The first device writes the control byte into the extension bitstream in the following 4 cases:

Case 1: the flag bit of the audio encoded data of the previous Nth frame in the control byte is 1, and the flag bit of the bandwidth extension data is 1.

The control byte, the audio encoded data of the previous Nth frame and the bandwidth extension data are combined to obtain the extension bitstream. It is configured that, the flag bit of the audio encoded data of the previous Nth frame indicates that the audio encoded data of the previous Nth frame exists in the extension bitstream, and the flag bit of the bandwidth extension data indicates that the bandwidth extension data exists in the extension bitstream. For example, the first device may splice (recombine) the control byte, the audio encoded data of the previous Nth frame, and the bandwidth extension data to obtain the extension bitstream, and configure the flag bit of the audio encoded data of the previous Nth frame in the control byte as 1, and the flag bit of the bandwidth extension data in the control byte as 1, to indicate that the extension bitstream carries the audio encoded data of the previous Nth frame and the bandwidth extension data.

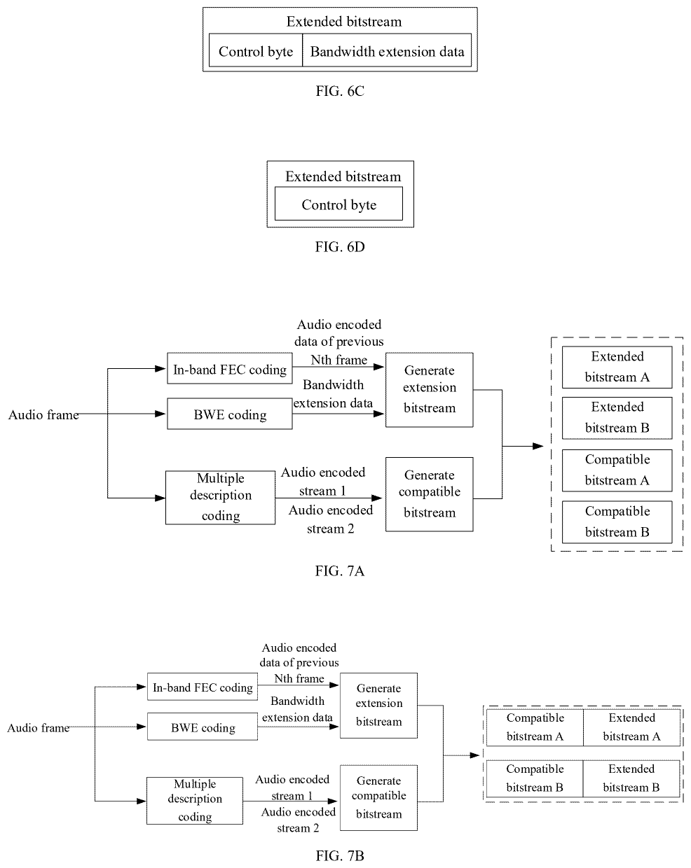

The extension bitstream in this case will be described below with reference to FIG. 6A.

FIG. 6A is a schematic diagram of an extension bitstream provided by an embodiment of the present disclosure. Please refer to FIG. 6A, where an extension bitstream is included. When the extension bitstream may include a control byte, audio encoded data of a previous Nth frame, and bandwidth extension data, a flag bit of the audio encoded data of the previous Nth frame in the control byte is 1, and a flag bit of the bandwidth extension data is 1.

Case 2: the flag bit of the audio encoded data of the previous Nth frame in the control byte is 1, and the flag bit of the bandwidth extension data is 0.

The control byte and the audio encoded data of the previous Nth frame are combined to obtain the extension bitstream, and it is configured that the flag bit of the audio encoded data of the previous Nth frame indicates that the audio encoded data of the previous Nth frame exists in the extension bitstream, and the flag bit of the bandwidth extension data indicates that the bandwidth extension data does not exist in the extension bitstream. For example, the first device may splice the control byte and the audio encoded data of the previous Nth frame to obtain an extension bitstream, and configure that the flag bit of the audio encoded data of the previous Nth frame in the control byte is 1, and the flag bit of the bandwidth extension data in the control byte is 0, to indicate that the bandwidth extension data carries the audio encoded data of the previous Nth frame.

The extension bitstream in this case will be described below with reference to FIG. 6B.

FIG. 6B is a schematic diagram of an extension bitstream provided by an embodiment of the present disclosure. Please refer to FIG. 6B, where an extension bitstream is included. When the extension bitstream includes a control byte and audio encoded data of a previous Nth frame, the flag bit of the audio encoded data of the previous Nth frame in the control byte is 1, and the flag bit of the bandwidth extension data in the control byte is 0.

Case 3: the flag bit of the audio encoded data of the previous Nth frame in the control byte is 0, and the flag bit of the bandwidth extension data in the control byte is 1.

The control byte and the bandwidth extension data are combined to obtain the extension bitstream. It is configured that, the flag bit of the audio encoded data of the previous Nth frame indicates that the audio encoded data of the previous Nth frame does not exist in the extension bitstream, and the flag bit of the bandwidth extension data indicates that the bandwidth extension data exists in the extension bitstream. For example, the first device may splice the control byte and the bandwidth extension data to obtain the extension bitstream, and configure that the flag bit of the audio encoded data of the previous Nth frame in the control byte is 0, and the flag bit of the bandwidth extension data in the control byte is 1, to indicate that the extension bitstream carries the bandwidth extension data.

The extension bitstream in this case will be described below with reference to FIG. 6C.

FIG. 6C is a schematic diagram of an extension bitstream provided by an embodiment of the present disclosure. Please refer to FIG. 6C, where an extension bitstream is included. When the extension bitstream includes a control byte and bandwidth extension data, a flag bit of audio encoded data of a previous Nth frame in the control byte is 0, and a flag bit of bandwidth extension data in the control byte is 1.

Case 4: the flag bit of the audio encoded data of the previous Nth frame in the control byte is 0, and the flag bit of the bandwidth extension data in the control byte is 0.

The control byte is determined as the extension bitstream. It is configured that the flag bit of the audio encoded data of the previous Nth frame indicates that the audio encoded data of the previous Nth frame does not exist in the extension bitstream, and the flag bit of the bandwidth extension data indicates that the bandwidth extension data does not exist in the extension bitstream. For example, the first device may determine the control byte as the extension bitstream, and configure that the flag bit of the audio encoded data of the previous Nth frame in the control byte is 0, and the flag bit of the bandwidth extension data is 0, to indicate that the audio encoded data of the previous Nth frame and the bandwidth extension data cannot be carried in the bandwidth extension data.

The extension bitstream in this case will be described below with reference to FIG. 6D.

FIG. 6D is a schematic diagram of an extension bitstream provided by an embodiment of the present disclosure. Please refer to FIG. 6D, where an extension bitstream is included. When the extension bitstream includes a control byte, a flag bit of audio encoded data of a previous Nth frame in the control byte is 0, and a flag bit of bandwidth extension data in the control byte is 0.

In some embodiments, the encoded data of the audio frame may be decoded to obtain the audio frame. For example, after the receiving end receives the encoded data of the audio frame, the audio frame may be decoded based on the encoded data. In some embodiments, the first device may generate the encoded data of the audio frame based on the following feasible implementation: acquiring capability information of the second device, and generating the encoded data of the audio frame based on the capability information, the at least two audio encoded streams and the extension bitstream.

In some embodiments, the second device may be a receiving end of the encoded data. In some embodiments, the capability information indicates whether the second device is capable of decoding the extension bitstream. For example, if the second device can only decode the audio encoded stream, the capability information is that the second device cannot decode the extension bitstream, and if the second device can decode the audio encoded stream and the extension bitstream, the capability information is that the second device can decode the extension bitstream.

In some embodiments, the capability information of the second device is preset information, and the first device may send a capability information acquisition request to the second device, or may store the capability information of the second device in advance, which is not limited in this disclosure.

In some embodiments, the encoded data of the audio frame is generated based on the capability information, the at least two audio encoded streams, and the extension bitstream in the following two cases:

Case 1: the capability information indicates that the second device cannot decode the extension bitstream.

In some embodiments, if the capability information indicates that the second device cannot decode the extension bitstream, a first processing operation is performed, where the first processing operation includes: determining at least two audio encoded streams and at least two extension bitstreams as the encoded data of the audio frame. In some embodiments, each audio encoded stream corresponds to an associated extension bitstream. For example, if the audio encoded stream includes an audio encoded stream A and an audio encoded stream B, the audio encoded stream A may be associated with an extension bitstream A, the audio encoded stream B may be associated with an extension bitstream B, and data included in the extension bitstream A and the extension bitstream B may be the same or different, which is not limited in the embodiments of the present disclosure. For example, the extension bitstream A may include the audio encoded data of the previous Nth frame, and the extension bitstream B may include the bandwidth extension data.

The encoded data in this case will be described below with reference to FIG. 7A.

FIG. 7A is a schematic diagram of a process for generating encoded data provided by an embodiment of the present disclosure. Please refer to FIG. 7A, where an audio frame is included. The audio frame is inputted to an in-band FEC encoder to obtain audio encoded data of a previous Nth frame, the audio frame is inputted to a BWE encoder to obtain bandwidth extension data, and the audio frame is inputted to a multiple description encoder to obtain an audio encoded stream 1 and an audio encoded stream 2.

Referring to FIG. 7A, an extension bitstream A and an extension bitstream B are obtained based on the audio encoded data of the previous Nth frame and the bandwidth extension data, where the data of the extension bitstream A and the data of the extension bitstream B may be the same. A compatible bitstream A and a compatible bitstream B are generated based on the audio encoded stream 1 and the audio encoded stream 2, where, the compatible bitstream A includes the audio encoded stream 1, and the compatible bitstream B includes the audio encoded stream 2. The first device determines that the encoded data of the audio frame includes the extension bitstream A, the extension bitstream B, the compatible bitstream A, and the compatible bitstream B.

Case 2: the capability information indicates that the second device can decode the extension bitstream.

In some embodiments, if the capability information indicates that the second device can decode the extension bitstream, the first device may combine the extension bitstream with at least two audio encoded streams respectively, to obtain the encoded data of the audio frame, or perform the first processing operation. For example, when the second device can decode the extension bitstream, if the audio encoded stream includes the audio encoded stream A and the audio encoded stream B, the first device may splice the extension bitstream with the audio encoded stream A, and splice (recombine) the extension bitstream with the audio encoded stream B, to then obtain encoded data corresponding to the audio frame.

The encoded data in this case will be described below with reference to FIG. 7B.

FIG. 7B is a schematic diagram of another process for generating encoded data provided by an embodiment of the present disclosure. Please refer to FIG. 7B, where an audio frame is included. The audio frame is inputted to an in-band FEC encoder to obtain audio encoded data of a previous Nth frame, the audio frame is inputted to a BWE encoder to obtain bandwidth extension data, and the audio frame is inputted to a multiple description encoder to obtain an audio encoded stream 1 and an audio encoded stream 2.

Referring to FIG. 7B, an extension bitstream A and an extension bitstream B are obtained based on the audio encoded data of the previous Nth frame and the bandwidth extension data, where the data of the extension bitstream A and the data of the extension bitstream B may be the same. A compatible bitstream A and a compatible bitstream B are generated based on the audio encoded stream 1 and the audio encoded stream 2, where, the compatible bitstream A includes the audio encoded stream 1, and the compatible bitstream B includes the audio encoded stream 2. The first device splices the compatible bitstream A and the extension bitstream A, and splices (recombines) the compatible bitstream B and the extension bitstream B, to obtain the encoded data of the audio frame.

It should be noted that, when the multiple description bitstream includes two audio encoded streams, the extension bitstream may include the following situations: the extension bitstreams associated with the two audio encoded streams may both include in-band FEC data and BWE data; the extension bitstreams associated with the two audio encoded streams do not include in-band FEC data and BWE data; the extension bitstream associated with one audio encoded stream includes in-band FEC data and BWE data, and the extension bitstream associated with the other audio encoded stream does not include in-band FEC data and BWE data; the extension bitstream associated with one audio encoded stream does not include in-band FEC data and BWE data, and the extension bitstream associated with the other audio encoded stream includes in-band FEC data and BWE data; the extension bitstream associated with one audio encoded stream includes in-band FEC data, and the extension bitstream associated with the other audio encoded stream includes BWE data; the extension bitstream associated with one audio encoded stream includes BWE data, and the extension bitstream associated with the other audio encoded stream includes in-band FEC data.

In the above embodiment, even without capability information, the encoded data corresponding to the audio frame may be generated by the above method, and the second device may decode the encoded data according to its own capability.

In some embodiments, for the audio encoded stream and the extension bitstream corresponding to each other, they may be transmitted using a same one data link, and they may be located at different positions in transmission data. For example, the audio encoded stream A and the extension bitstream A are transmitted through one data link, the audio encoded stream B and the extension bitstream B are transmitted through another data link, the audio encoded stream may be located at a position of a payload of real-time transport protocol packets, and the extension bitstream may be located at a position of an extension header of the real-time transport protocol packets. In this way, the second device can decode the audio encoded stream in the payload without the need to decode the extension bitstream in the extension header.

In some embodiments, in the encoded data outputted by the first device, for the audio encoded stream and the extension bitstream corresponding to each other, the control byte of the extension bitstream is before the frame header byte of the audio encoded stream, and the audio encoded data of the previous Nth frame and the extension data of the extension bitstream are located after the audio encoded stream. A plurality of spliced extension bitstreams and audio encoded streams are transmitted using different data links. For example, data spliced by the audio encoded stream A and the extension bitstream A is transmitted through one data link, and data spliced by the audio encoded stream B and the extension bitstream B is transmitted through another data link.

The embodiment of the present disclosure provides an audio processing method in which, a first device acquires at least two audio encoded streams and an extension bitstream according to an audio frame; and generates encoded data of the audio frame based on the at least two audio encoded streams and the extension bitstream. In this way, when continuous packet loss occurs, a second device can recover the audio frame with continuous packet loss based on the at least two audio encoded streams, and the audio encoded data of the previous Nth frame in the extension bitstream can also assist the second device to recover the audio frame, and the bandwidth extension data can improve the quality of the audio frame, thereby improving the audio playing effect.

On the basis of the embodiment shown in FIG. 2, another audio processing method is explained below with reference to FIG. 8.

FIG. 8 is a schematic diagram of another audio processing method provided by an embodiment of the present disclosure. Referring to FIG. 8, the method includes: steps S801 to S802. An execution subject of this embodiment may be a second device, and may also be an audio processing apparatus provided in the second device. The audio processing apparatus may be implemented based on software, or the audio processing apparatus may be implemented based on a combination of software and hardware.

In step S801, at least two audio encoded streams and an extension bitstream are acquired according to encoded data of an audio frame.

The second device may receive the encoded data of the audio frame transmitted by the first device.

In some embodiments, the extension bitstream includes audio encoded data of a previous Nth frame of the audio frame and/or bandwidth extension data of the audio frame, where N is an integer greater than 0, and the at least two audio encoded streams are associated with multiple description coding of the audio frame and may be generated by using the multiple description coding. The at least two audio encoded streams may be used to decode the audio frame, and the second device may receive the encoded data of the audio frame transmitted by the first device. For example, after the first device generates the encoded data of the audio frame based on the audio encoded streams and the extension bitstream, the first device may transmit the encoded data to the second device.

In step S802, the at least two audio encoded streams and the extension bitstream are decoded to obtain the audio frame.

In some embodiments, capability information of the second device is configured to indicate whether the second device is capable of decoding the extension bitstream. For example, when the second device receives the encoded data of the audio frame, the second device may determine capability information in advance, and when the capability information is different, the second device may decode the encoded data based on a different decoding mode.

In some embodiments, the extension bitstream includes a control byte which includes: at least one of configuration information of the at least two audio encoded streams, configuration information of an in-band forward error correction coding FEC, or configuration information of bandwidth extension data.

In some embodiments, the configuration information of the at least two audio encoded streams comprises at least one of a number of the at least two audio encoded streams, or an index of each of the at least two audio encoded streams; the configuration information of the in-band FEC comprises information indicating whether in-band FEC data is carried, wherein the audio encoded data of the previous Nth frame is the in-band FEC data; and the configuration information of the bandwidth extension data comprises information indicating whether the bandwidth extension data is carried.

In some embodiments, the decoding the at least two audio encoded streams and the extension bitstream includes: acquiring the bandwidth extension data from the extension bitstream, and decoding the bandwidth extension data and the at least two audio encoded streams to obtain the audio frame, in a case where the configuration information of the bandwidth extension data indicates that the bandwidth extension data is carried.

In some embodiments, the second device decodes the encoded data based on the capability information in the following two cases.

Case 1: the second device can decode the extension bitstream.

If the capability information of the second device indicates that the second device can decode the extension bitstream, the at least two audio encoded streams and the extension bitstream are acquired in the encoded data, and the encoded data is decoded based on the at least two audio encoded streams and the extension bitstream. For example, if the second device can decode the extension bitstream, the encoded data is spliced coding of the audio encoded stream and the extension bitstream, and the second device can directly acquire the extension bitstream and the at least two audio encoded streams in the spliced coding for decoding.

In some embodiments, the second device decodes the encoded data based on the audio encoded streams and the extension bitstream, specifically: acquiring a control byte in the extension bitstream; if the control byte indicates that bandwidth extension data exists in the extension bitstream, acquiring the bandwidth extension data in the extension bitstream and decoding the encoded data based on the at least two audio encoded streams and the bandwidth extension data; and if the control byte indicates that the bandwidth extension data does not exist in the extension bitstream, decoding the encoded data based on the at least two audio encoded streams.

For example, the second device parses the control byte in a header of the bitstream, to obtain a number of the audio encoded streams, an index of the audio encoded streams, a flag bit of audio encoded data of a previous Nth frame, and a flag bit of bandwidth extension data. If the flag bit of the audio encoded data of the previous Nth frame is true, the audio encoded data of the previous Nth frame is taken out from the tail of the encoded data, and if the flag bit of the bandwidth extension data is true, the bandwidth extension data is taken out based on the same method. Because a length of the audio encoded data of the previous Nth frame and the bandwidth extension data is fixed, the second device may subtract the length of the audio encoded data of the previous Nth frame, the bandwidth extension data, and the frame header byte from a total length of the encoded data to obtain the length of the audio encoded stream, thereby acquiring the audio encoded stream from the bitstream.

For example, if the second device receives encoded data in two data links of the current frame, the second device acquires in-band FEC data and BWE data from the extension bitstream based on the control byte, discards the in-band FEC data, and inputs two audio encoded streams and the BWE data to the decoder, thereby obtaining the current frame.

For example, if the second device receives encoded data in one data link of the current frame, the second device acquires in-band FEC data and BWE data in an extension bitstream based on the control byte and discards the in-band FEC data, and inputs acquired one audio encoded stream and the BWE data to the decoder, thereby obtaining the current frame.

In some embodiments, the decoding method of the second device further includes: if the second device does not receive the encoded data of the audio frame sent by the first device, acquiring target encoded data associated with an audio frame after the Nth frame of the current frame (audio frame), and decoding the current audio frame based on the target encoded data.

In some embodiments, the decoding of the current audio frame based on the target encoded data, specifically is: acquiring an extension bitstream in the target encoded data, acquiring audio encoded data of the current audio frame in the extension bitstream, and decoding the audio encoded data of the current audio frame. For example, after receiving encoded data of multiple audio frames, the second device may store the multi-frame encoded data in a buffer, and when decoding the current audio frame, if the second device does not receive the encoded data, the second device may acquire the encoded data after the Nth frame from the buffer, so as to obtain the encoded data of the current audio frame.

In some embodiments, if the second device cannot obtain the target encoded data, the second device may decode and output an audio signal based on a preset packet loss concealment algorithm, so that although the quality of the decoded audio signal is poor, the second device may also output a continuous audio, avoiding audio lag and improving the quality of the audio.

Case 2: the second device cannot decode the extension bitstream.

If the capability information indicates that the second device cannot decode the extension bitstream, the second device may acquire at least two audio encoded streams from the encoded data and decode the encoded data based on the at least two audio encoded streams. For example, if the second device receives encoded data in two data links of the current frame, the second device may randomly discard data in one data link, filter an extension bitstream in the remaining encoded data, and input an audio encoded stream to the decoder, thereby obtaining the current frame; if the second device only receives the encoded data in one data link of the current frame, the second device filters the extension bitstream in the encoded data and inputs the audio encoded stream to the decoder, thereby obtaining a frame.

The embodiment of the disclosure provides an audio processing method including: receiving encoded data of an audio frame sent by a first device, obtaining capability information of a second device, obtaining an audio encoded stream and an extension bitstream from the encoded data and decoding the encoded data based on the audio encoded stream and the extension bitstream if the capability information of the second device indicates that the second device can decode the extension bitstream; and acquiring an audio encoded stream from the encoded data and decoding the encoded data based on the audio encoded stream by the second device if the capability information indicates that the second device cannot decode the extension bitstream. In this way, the second device can recover the audio frame with continuous packet loss based on at least two audio encoded streams, the audio encoded data of the previous Nth frame can also assist the second device to recover the audio frame, and the bandwidth extension data can improve the quality of the audio frame, thereby improving the audio playing effect.

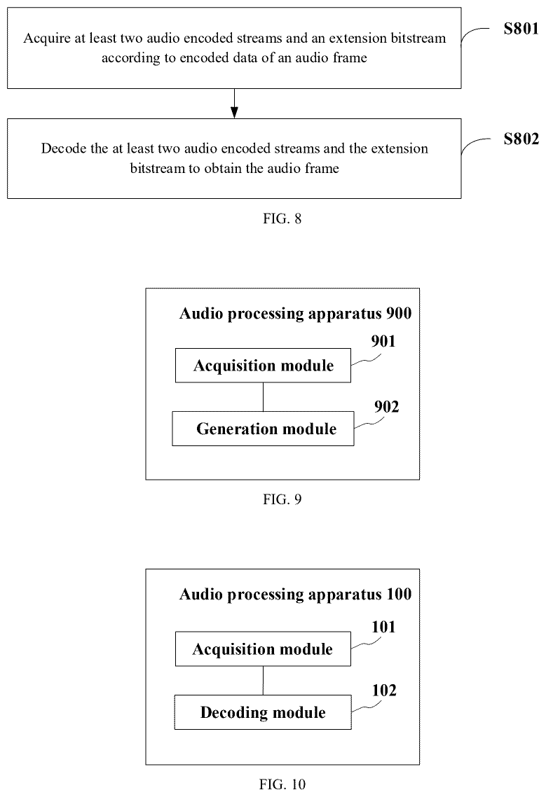

FIG. 9 is a schematic structural diagram of an audio processing apparatus provided by an embodiment of the present disclosure. Referring to FIG. 9, the audio processing apparatus 900 includes an acquisition module 901 and a generation module 902.

The acquisition module 901 is configured to acquire at least two audio encoded streams and an extension bitstream according to an audio frame.

The generation module 902 is configured to generate encoded data of the audio frame based on the at least two audio encoded streams and the extension bitstream.

In some embodiments, the at least two audio encoded streams are generated by multiple description coding according to the audio frame, and the extension bitstream comprises audio encoded data of a previous Nth frame of the audio frame and/or bandwidth extension data of the audio frame, where N is an integer greater than 0.

In some embodiments, the generation module 902 is specifically configured to determine the at least two audio encoded streams and the extension bitstream as the encoded data of the audio frame.

In some embodiments, the generation module 902 is specifically configured to, recombine each of the at least two audio encoded streams and one extension bitstream corresponding to the each of the at least two audio encoded streams into one bitstream as the encoded data of the audio frame, in a case where the each of the at least two audio encoded streams corresponds to one extension bitstream; or recombine each of part of the at least two audio encoded streams and one extension bitstream corresponding to the each of the part of the at least two audio encoded streams into one bitstream, and determining the recombined bitstream and an audio encoded stream except the part of the audio encoded streams as the encoded data of the audio frame, in a case where the each of the part of the at least two audio encoded streams corresponds to one extension bitstream.

In some embodiments, the generation module 902 is configured to: generate a control byte based on the at least two audio encoded streams and the extension bitstream, where, the control byte comprises at least one of configuration information of the at least two audio encoded streams, configuration information of an in-band forward error correction coding (FEC) or configuration information of bandwidth extension data; and write the control byte into the encoded data of the audio frame.

In some embodiments, the configuration information of the at least two audio encoded streams comprises at least one of a number of the at least two audio encoded streams, or an index of each of the at least two audio encoded streams; the configuration information of the in-band FEC comprises information indicating whether in-band FEC data is carried, wherein the audio encoded data of the previous Nth frame is the in-band FEC data; and the configuration information of the bandwidth extension data comprises information indicating whether the bandwidth extension data is carried.

In some embodiments, the generation module 902 is configured to write the control byte into the extension bitstream, where: the configuration information of the in-band FEC is configured for indicating that the in-band FEC data is carried, and the configuration information of the bandwidth extension data is configured for indicating that the bandwidth extension data is carried, in a case where the extension bitstream comprises the in-band FEC data and the bandwidth extension data; the configuration information of the in-band FEC is configured for indicating that the in-band FEC data is carried, and the configuration information of the bandwidth extension data is configured for indicating that the bandwidth extension data is not carried, in a case where the extension bitstream comprises the in-band FEC data and does not comprise the bandwidth extension data; the configuration information of the in-band FEC is configured for indicating that the in-band FEC data is not carried, and the configuration information of the bandwidth extension data is configured for indicating that the bandwidth extension data is carried, in a case where the extension bitstream does not comprise the in-band FEC data and comprises the bandwidth extension data; and the configuration information of the in-band FEC is configured for indicating that the in-band FEC data is not carried, and the configuration information of the bandwidth extension data is configured for indicating that the bandwidth extension data is not carried, in a case where the extension bitstream does not comprise the in-band FEC data and the bandwidth extension data.

In some embodiments, the generation module 902 is specifically configured to: acquire capability information of the second device, where the capability information indicates whether the second device can decode the extension bitstream; and generate the encoded data of the audio frame based on the capability information, the at least two audio encoded streams and the extension bitstream.

In some embodiments, the generation module 902 is specifically configured to: acquire capability information of the second device, where the capability information indicates whether the second device is capable of decoding the extension bitstream; and generate the encoded data of the audio frame based on the capability information, the at least two audio encoded streams and the extension bitstream.

In some embodiments, the generation module 902 is specifically configured to: if the capability information indicates that the second device cannot decode the extension bitstream, execute a first processing operation, where the first processing operation includes: determining the at least two audio encoded streams and at least two extension bitstreams as the encoded data of the audio frame.

In some embodiments, the generation module 902 is specifically configured to: if the capability information indicates that the second device can decode the extension bitstream, combine the extension bitstream with the at least two audio encoded streams respectively, to obtain the encoded data of the audio frame, or execute the first processing operation.

In some embodiments, the generation module 902 is specifically configured to: acquire audio information of the audio frame, where the audio information includes at least one of: a frame length, coding bandwidth or channel number of the audio frame; encode the audio frame based on a multiple description coding mode to obtain at least two data bitstreams associated with the audio frame; and determine the at least two audio encoded streams according to the audio information and the at least two data bitstreams.

In some embodiments, the generation module 902 is specifically configured to: determine a frame header byte of the data bitstream based on the audio information; and respectively combine the frame header byte with the at least two data bitstreams to obtain the at least two audio encoded streams.

The audio processing apparatus provided in the embodiment of the present disclosure may be configured to execute the technical solutions of the above method embodiments, and the implementation principle and the technical effects are similar, which are not described herein again.

FIG. 10 is a schematic structural diagram of another audio processing apparatus according to an embodiment of the present disclosure. Referring to FIG. 10, the audio processing apparatus 100 includes an acquisition module 101 and a decoding module 102.

The acquisition module 101 is configured to acquire at least two audio encoded streams and an extension bitstream according to encoded data of an audio frame.

In some embodiments, the encoded data includes an extension bitstream associated with the audio frame and at least two audio encoded streams, where the extension bitstream includes audio encoded data of a previous Nth frame of the audio frame and/or bandwidth extension data of the audio frame, where N is an integer greater than 0, and the at least two audio encoded streams are associated with multiple description coding of the audio frame and may be generated by multiple description coding.

The decoding module 102 is configured to decode the at least two audio encoded streams and the extension bitstream to obtain the audio frame.

In some embodiments, the extension bitstream comprises a control byte which comprises at least one of configuration information of the at least two audio encoded streams, configuration information of an in-band forward error correction coding (FEC) or configuration information of bandwidth extension data.

In some embodiments, the configuration information of the at least two audio encoded streams comprises at least one of a number of the at least two audio encoded streams, or an index of each of the at least two audio encoded streams; the configuration information of the in-band FEC comprises information indicating whether in-band FEC data is carried, where the audio encoded data of the previous Nth frame is the in-band FEC data; and the configuration information of the bandwidth extension data comprises information indicating whether the bandwidth extension data is carried.

In some embodiments, the decoding module 102 is configured to acquire the bandwidth extension data from the extension bitstream, and decode the bandwidth extension data and the at least two audio encoded streams to obtain the audio frame, in a case where the configuration information of the bandwidth extension data indicates that the bandwidth extension data is carried.

The decoding module 102 may acquire capability information of the second device, where the capability information indicates whether the second device can decode the extension bitstream; and decode the encoded data based on the capability information.

In some embodiments, the decoding module 102 is specifically configured to: if the capability information indicates that the second device can decode the extension bitstream, acquire the at least two audio encoded streams and the extension bitstream from the encoded data, and decode the encoded data based on the at least two audio encoded streams and the extension bitstream; if the capability information indicates that the second device cannot decode the extension bitstream, acquire the at least two audio encoded streams from the encoded data, and decode the encoded data based on the at least two audio encoded streams.

In some embodiments, the decoding module 102 is specifically configured to: acquire a control byte from the extension bitstream; if the control byte indicates that bandwidth extension data exists in the extension bitstream, acquire the bandwidth extension data in the extension bitstream, and decode the encoded data based on the at least two audio encoded streams and the bandwidth extension data; and if the control byte indicates that bandwidth extension data does not exist in the extension bitstream, decode the encoded data based on the at least two audio encoded streams.

In some embodiments, the decoding module 102 is further configured to: if the second device does not receive the encoded data of the audio frame sent from the first device, acquire target encoded data associated with an audio frame after the Nth frame of the current frame (the audio frame); acquire an extension bitstream from the target encoded data; and acquire audio encoded data of the current frame from the extension bitstream, and decode the audio encoded data of the current frame.

The audio processing apparatus provided by the embodiment of the present disclosure may be configured to execute the technical solutions of the above method embodiments, and the implementation principle and the technical effects are similar, which are not described herein again.

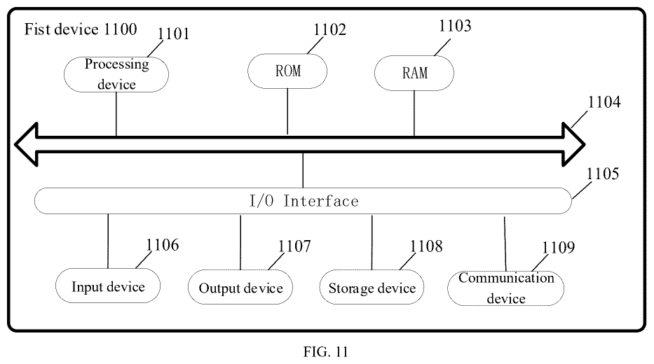

FIG. 11 is a schematic structural diagram of an electronic device provided by an embodiment of the present disclosure. Referring to FIG. 11, a schematic structural diagram of an electronic device 1100 suitable for implementing the embodiment of the present disclosure is shown, where the electronic device 1100 may be a terminal device or a server. Among them, the terminal device may include, but is not limited to, a mobile terminal such as a mobile phone, a notebook computer, a digital broadcast receiver, a Personal Digital Assistant (PDA), a tablet computer (PAD), a Portable Multimedia Player (PMP), a car terminal (e.g., a car navigation terminal), etc., and a fixed terminal such as a digital TV, a desktop computer, etc. The electronic device shown in FIG. 11 is only an example, and should not bring any limitation to the functions and the use range of the embodiment of the present disclosure.

As shown in FIG. 11, the electronic device 1100 may include a processing means (e.g., a central processing unit, a graphics processor, etc.) 1101, which may perform various suitable actions and processes according to a program stored in a Read Only Memory (ROM) 1102 or a program loaded from a storage means 1108 into a Random Access Memory (RAM) 1103. In the RAM 1103, various programs and data necessary for the operation of the electronic device 1100 are also stored. The processing means 1101, the ROM 1102, and the RAM 1103 are connected to each other via a bus 1104. An input/output (I/O) interface 1105 is also connected to the bus 1104.

Generally, the following means may be connected to the I/O interface 1105: an input means 1106 including, for example, a touch screen, touch pad, keyboard, mouse, camera, microphone, accelerometer, gyroscope, or the like; an output means 1107 including, for example, a Liquid Crystal Display (LCD), a speaker, a vibrator, or the like; a storage means 1108, including, for example, magnetic tape, hard disk, or the like; and a communication means 1109. The communication means 1109 may allow the electronic device 1100 to communicate wirelessly or by wire with other devices to exchange data. While FIG. 11 illustrates the electronic device 1100 having various means, it is to be understood that not all illustrated means are required to be implemented or provided. More or fewer means may be alternatively implemented or provided.

An embodiment of the present disclosure further provides an electronic device, including: one or more processors and one or more memories, where the one or more memories are configured to store computer-executable instructions, which when executed by the one or more processors cause the one or more processors to perform the audio processing method according to any of the embodiments described above.

An embodiment of the present disclosure further provides a computer-readable storage medium having stored thereon computer-executable instructions which, when executed by a processor, cause the processor to implement any one of the embodiments described above.

In particular, the processes described above with reference to the flow diagrams may be implemented as a computer software program, according to the embodiments of the present disclosure. For example, the embodiments of the present disclosure include a computer program product including a computer program carried on a computer-readable medium, the computer program including program code for performing the method illustrated by the flow diagram. In such an embodiment, the computer program may be downloaded and installed from a network via the communication means 1109, or installed from the storage means 1108, or installed from the ROM 1102. When executed by the processing means 1101, the computer program performs the above functions defined in the methods of the embodiments of the present disclosure.

It should be noted that the computer readable medium of the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium that can contain, or store a program for use by or in connection with an instruction execution system, apparatus, or device. In contrast, in the present disclosure, the computer readable signal medium may include a propagated data signal with computer readable program code embodied therein, for example, in baseband or as part of a carrier wave. Such a propagated data signal may take any of a variety of forms, including, but not limited to, electro-magnetic, optical, or any suitable combination thereof. The computer readable signal medium may be any computer readable medium other than the computer readable storage medium and that can communicate, propagate, or transport a program for use by or in connection with an instruction execution system, apparatus, or device. Program code embodied on the computer readable medium may be transmitted using any appropriate medium, including but not limited to: electrical wires, optical cables, RF (radio frequency), etc., or any suitable combination of the foregoing.

The computer readable medium may be embodied in the electronic device; or may be separate and not assembled into the electronic device.

The computer readable medium carries one or more programs which, when executed by the electronic device, cause the electronic device to perform the method shown in the above embodiments.

Computer program code for carrying out operations for aspects of the present disclosure may be written in any combination of one or more programming languages, including an object oriented programming language such as Java, Smalltalk, C++, and conventional procedural programming languages, such as the “C” language or similar programming languages. The program code may execute entirely on the user's computer, partly on the user's computer, as a stand-alone software package, partly on the user's computer and partly on a remote computer or entirely on the remote computer or server. In the situation where the remote computer is involved, the remote computer may be connected to the user's computer through any type of network, including a Local Area Network (LAN) or a Wide Area Network (WAN), or may be connected to an external computer (for example, through the Internet using an Internet service provider).

The flow and block diagrams in the figures illustrate the architecture, functionality, and operation of possible implementations of the systems, methods and computer program products according to various embodiments of the present disclosure. In this regard, each block in the flow or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in a reverse order, depending upon the functionality involved. It will also be noted that each block of the block and/or flow diagrams, and combinations of blocks in the block and/or flow diagrams, can be implemented by special purpose hardware-based systems that perform the specified functions or operations, or combinations of special purpose hardware and computer instructions.

The units described in the embodiments of the present disclosure may be implemented by software or hardware. A name of a unit does not in some cases constitute a limitation of the unit itself, for example, the first acquiring unit may also be described as a “unit configured to acquire at least two internet protocol addresses”.

The functions described herein above may be performed, at least in part, by one or more hardware logic components. For example, without limitation, exemplary types of hardware logic components that may be used include: field Programmable Gate Array (FPGA), Application Specific Integrated Circuit (ASIC), Application Specific Standard Product (ASSP), system on a chip (SOC), Complex Programmable Logic Device (CPLD), and the like.

In the context of this disclosure, the machine-readable medium may be a tangible medium that can contain, or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection based on one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

It is noted that references to “a” or “an” in this disclosure are intended to be illustrative rather than limiting, and that those skilled in the art should appreciate that, they should be understood as “one or more” unless the context clearly indicates otherwise.

The names of messages or information exchanged between devices in the embodiments of the present disclosure are for illustrative purposes only, and are not intended to limit the scope of the messages or information.

It is understood that, before the technical solutions disclosed in the embodiments of the present disclosure are used, the user should be notified of the type, use range, use scene, etc. of personal information related to the present disclosure in a proper manner according to the relevant laws and regulations, and the authorization from the user should be obtained.

For example, in response to receiving a user's active request, a prompt is sent to the user to explicitly prompt the user that the requested operation to be performed would require acquisition and use of personal information to the user. Thus, the user can autonomously select whether to provide the personal information to software or hardware such as an electronic device, an application program, a server, or a storage medium that performs the operations of the technical solution of the present disclosure, according to the prompt.

As an alternative but non-limiting implementation, in response to receiving an active request from the user, the manner of sending the prompt to the user may be, for example, a pop-up window, and the prompt may be presented in a text manner in the pop-up window. In addition, a selection control for the user to select “agree” or “disagree” providing the personal information to the electronic device can be carried in the popup window.

It is understood that the above notification and user authorization process is only illustrative and is not intended to limit the implementation of the present disclosure, and other ways of satisfying the relevant laws and regulations may be applied to the implementation of the present disclosure.

It will be appreciated that the data referred to in this disclosure, including but not limited to the data itself, the acquisition or use of the data, should comply with the requirements of the applicable laws and regulations and related provisions. The data may include information, parameter, messages, etc., such as cut flow indication information.

The foregoing is illustration of the preferred embodiments of the present disclosure and the technical principles employed. It should be appreciated by those skilled in the art that the disclosure scope involved in the present disclosure is not limited to the technical solutions formed by specific combinations of the above technical features, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing may be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

What is claimed is:

1. An audio processing method, comprising:
acquiring at least two audio encoded streams and an extension bitstream according to an audio frame; and
generating encoded data of the audio frame based on the at least two audio encoded streams and the extension bitstream.

2. The audio processing method according to claim 1, wherein the at least two audio encoded streams are generated by multiple description coding according to the audio frame, and the extension bitstream comprises audio encoded data of a previous Nth frame of the audio frame and/or bandwidth extension data of the audio frame, where N is an integer greater than 0.

3. The audio processing method according to claim 1, wherein the generating encoded data of the audio frame based on the at least two audio encoded streams and the extension bitstream comprises:
determining the at least two audio encoded streams and the extension bitstream as the encoded data of the audio frame.

4. The audio processing method according to claim 1, wherein the generating encoded data of the audio frame based on the at least two audio encoded streams and the extension bitstream comprises:
recombining each of the at least two audio encoded streams and one extension bitstream corresponding to the each of the at least two audio encoded streams into one bitstream as the encoded data of the audio frame, in a case where the each of the at least two audio encoded streams corresponds to one extension bitstream; or
recombining each of part of the at least two audio encoded streams and one extension bitstream corresponding to the each of the part of the at least two audio encoded streams into one bitstream, and determining the recombined bitstream and an audio encoded stream except the part of the audio encoded streams as the encoded data of the audio frame, in a case where the each of the part of the at least two audio encoded streams corresponds to one extension bitstream.

5. The audio processing method according to claim 2, wherein the generating encoded data of the audio frame based on the at least two audio encoded streams and the extension bitstream comprises:
generating a control byte based on the at least two audio encoded streams and the extension bitstream, wherein the control byte comprises at least one of configuration information of the at least two audio encoded streams, configuration information of an in-band forward error correction coding (FEC) or configuration information of bandwidth extension data; and
writing the control byte into the encoded data of the audio frame.

6. The audio processing method according to claim 5, wherein:
the configuration information of the at least two audio encoded streams comprises at least one of a number of the at least two audio encoded streams, or an index of each of the at least two audio encoded streams;
the configuration information of the in-band FEC comprises information indicating whether in-band FEC data is carried, wherein the audio encoded data of the previous Nth frame is the in-band FEC data; and
the configuration information of the bandwidth extension data comprises information indicating whether the bandwidth extension data is carried.

7. The audio processing method according to claim 6, wherein the writing the control byte into the encoded data of the audio frame comprises:
writing the control byte into the extension bitstream, wherein:
the configuration information of the in-band FEC is configured for indicating that the in-band FEC data is carried, and the configuration information of the bandwidth extension data is configured for indicating that the bandwidth extension data is carried, in a case where the extension bitstream comprises the in-band FEC data and the bandwidth extension data;
the configuration information of the in-band FEC is configured for indicating that the in-band FEC data is carried, and the configuration information of the bandwidth extension data is configured for indicating that the bandwidth extension data is not carried, in a case where the extension bitstream comprises the in-band FEC data and does not comprise the bandwidth extension data;
the configuration information of the in-band FEC is configured for indicating that the in-band FEC data is not carried, and the configuration information of the bandwidth extension data is configured for indicating that the bandwidth extension data is carried, in a case where the extension bitstream does not comprise the in-band FEC data and comprises the bandwidth extension data; and
the configuration information of the in-band FEC is configured for indicating that the in-band FEC data is not carried, and the configuration information of the bandwidth extension data is configured for indicating that the bandwidth extension data is not carried, in a case where the extension bitstream does not comprise the in-band FEC data and the bandwidth extension data.

8. An audio processing method, comprising:
acquiring at least two audio encoded streams and an extension bitstream according to encoded data of an audio frame; and
decoding the at least two audio encoded streams and the extension bitstream to obtain the audio frame.

9. The audio processing method according to claim 8, wherein the at least two audio encoded streams are generated by multiple description coding according to the audio frame, and the extension bitstream comprises audio encoded data of a previous Nth frame of the audio frame and/or bandwidth extension data of the audio frame, where N is an integer greater than 0.

10. The audio processing method according to claim 8, wherein the extension bitstream comprises a control byte which comprises at least one of configuration information of the at least two audio encoded streams, configuration information of an in-band forward error correction coding (FEC) or configuration information of bandwidth extension data.

11. The audio processing method according to claim 10, wherein:
the configuration information of the at least two audio encoded streams comprises at least one of a number of the at least two audio encoded streams, or an index of each of the at least two audio encoded streams;
the configuration information of the in-band FEC comprises information indicating whether in-band FEC data is carried, wherein the audio encoded data of the previous Nth frame is the in-band FEC data; and
the configuration information of the bandwidth extension data comprises information indicating whether the bandwidth extension data is carried.

12. The audio processing method according to claim 11, wherein the decoding the at least two audio encoded streams and the extension bitstream comprises:
acquiring the bandwidth extension data from the extension bitstream, and decoding the bandwidth extension data and the at least two audio encoded streams to obtain the audio frame, in a case where the configuration information of the bandwidth extension data indicates that the bandwidth extension data is carried.

13. The audio processing method according to claim 8, further comprising:
acquiring target encoded data associated with an audio frame after the Nth frame of the audio frame in a case where the encoded data of the audio frame is not received;
acquiring a target extension bitstream from the target encoded data; and
acquiring the audio encoded data of the audio frame from the target extension bitstream, and decoding the audio encoded data of the audio frame.

14. An electronic device, comprising: one or more processors and one or more memories, wherein:
the one or more memories are configured to store computer-executable instructions, which when executed by the one or more processors cause the one or more processors to perform the audio processing method according to claim 1.

15. The electronic device according to claim 14, wherein the at least two audio encoded streams are generated by multiple description coding according to the audio frame, and the extension bitstream comprises audio encoded data of a previous Nth frame of the audio frame and/or bandwidth extension data of the audio frame, where N is an integer greater than 0.

16. The electronic device according to claim 14, wherein the generating encoded data of the audio frame based on the at least two audio encoded streams and the extension bitstream comprises:
determining the at least two audio encoded streams and the extension bitstream as the encoded data of the audio frame; or
recombining each of the at least two audio encoded streams and one extension bitstream corresponding to the each of the at least two audio encoded streams into one bitstream as the encoded data of the audio frame, in a case where the each of the at least two audio encoded streams corresponds to one extension bitstream; or
recombining each of part of the at least two audio encoded streams and one extension bitstream corresponding to the each of the part of the at least two audio encoded streams into one bitstream, and determining the recombined bitstream and an audio encoded stream except the part of the audio encoded streams as the encoded data of the audio frame, in a case where the each of the part of the at least two audio encoded streams corresponds to one extension bitstream.

17. An electronic device, comprising: one or more processors and one or more memories, wherein:
the one or more memories are configured to store computer-executable instructions, which when executed by the one or more processors cause the one or more processors to perform the audio processing method according to claim 8.

18. The electronic device according to claim 17, wherein the extension bitstream comprises a control byte which comprises at least one of configuration information of the at least two audio encoded streams, configuration information of an in-band forward error correction coding (FEC) or configuration information of bandwidth extension data.

19. A non-transitory computer-readable storage medium having stored thereon computer-executable instructions which, when executed by a processor, cause the processor to implement the audio processing method according to claim 1.

20. A non-transitory computer-readable storage medium having stored thereon computer-executable instructions which, when executed by a processor, cause the processor to implement the audio processing method according to claim 8.
